(19) United States
(12) Patent Application Publication
(10) Pub. No.: US 2024/0428031 A1
(43) Pub. Date: Dec. 26, 2024

(54) METHOD FOR READING A MARKING, AND WORKPIECE

(71) Applicant: Fraunhofer-Gesellschaft zur Förderung der angewandten Forschung e.V., Muenchen (DE)

(72) Inventors: Thomas Härtling, Dresden (DE); Matthias Schröder, Dresden (DE); Marek Rjelka, Dresden (DE); Christoph Kroh, Dresden (DE); Björn Erik Mai, Dresden (DE); Manuela Heymann, Dresden (DE)

(21) Appl. No.: 18/746,916

(22) Filed: Jun. 18, 2024

(30) Foreign Application Priority Data
Jun. 20, 2023 (DE) 102023116057.5

(51) Int. Cl. G06K 7/12; B21J 5/02

(52) U.S. Cl. CPC G06K 7/12; B21J 5/022

(57) ABSTRACT

In an embodiment a method for reading a marking includes providing the marking on a substrate, the marking being formed with at least one marking material, providing at least one opaque covering layer covering the marking, briefly irradiating the at least one covering layer with electromagnetic radiation to which the at least one covering layer is impermeable; and contactless reading the marking by thermal imaging.

### CROSS-REFERENCE TO RELATED APPLICATIONS

This application claims priority of German Application No. 102023116057.5, filed on Jun. 20, 2023, which application is hereby incorporated herein by reference.

### TECHNICAL FIELD

A method for reading a marking is provided. In addition, a workpiece intended for such a method is provided.

### BACKGROUND

Documents EP 3 650 238 A1, WO 2018/065228 A1 and US 2016/0339495 A1 concern marking methods.

### SUMMARY

Embodiments provide a method with which a marking can be read efficiently and reliably.

According to at least one embodiment, the method comprises the step of providing the marking. In particular, the marking is applied to a workpiece, such as a body part for a motor vehicle. The marking may be located on a substrate. The substrate is, for example, a metal body, such as a metal sheet. The marking is, for example, a label of a workpiece, with which the workpiece can be uniquely identified.

According to at least one embodiment, the marking comprises or consists of one or more marking materials. For example, a marking material is present which produces an optical contrast with respect to the substrate; “optical” in this context means, for example, at least part of the spectral range from 300 nm to 1.3 μm. Alternatively or additionally, a marking material is present which serves as an adhesion promoter so that the marking is firmly bonded to the substrate. Alternatively or additionally, a marking material is present with which a thermal conductivity of the marking is set, for example, a material that is less thermally conductive than the substrate; this can enable a thermal contrast to the substrate; “thermal” in this context means, for example, at least part of the spectral range from 3 μm to 15 μm.

According to at least one embodiment, the method comprises the step of providing at least one opaque covering layer. The covering layer completely or partially covers the marking. Opaque means in particular that the marking cannot be read visually due to the covering layer. “Visually” refers, for example, to the spectral range from 300 nm to 1.3 μm or from 400 nm to 0.9 μm or from 450 nm to 780 nm. In the spectral range in question, the covering layer comprises, for example, an optical density for single transmission of at least 1.5 or of at least 2.5 or of at least 4; in other words, the covering layer is impermeable to this radiation. For an optical density OD, the transmittance of a radiation is 10-OD.

The two aforementioned process steps can be carried out simultaneously. This means, for example, that a workpiece is then provided that comprises the substrate, the marking and the cover layer.

According to at least one embodiment, the method comprises the step of irradiating the at least one covering layer with an electromagnetic radiation to which the at least one covering layer is impermeable. With regard to “impermeable”, reference is made to the definition two paragraphs above. In particular, the irradiation is a short-term irradiation. For example, irradiation is carried out by means of a flash of light.

According to at least one embodiment, the method comprises the step of reading the marking by means of thermal imaging. The reading can, for example, be contactless. By means of thermal imaging means, for example, that the reading is performed by means of a thermal imaging camera and/or an infrared camera.

In at least one embodiment, the method is used for reading out a marking and comprises the following steps, for example in the order given:
A) providing the marking on a substrate, the marking being formed with at least one marking material,
B) providing at least one opaque covering layer which covers the marking,
C) briefly irradiating the at least one covering layer with electromagnetic radiation to which the at least one covering layer is opaque, and
D) reading out the marking without contact by means of thermal imaging.

To track metallic components, for example, throughout the entire machining process, it is necessary to apply a marking that is ideally legible after each machining step. One possible marking that can withstand processing steps such as hot metal sheet forming processes such as press hardening, even at high temperatures of more than 1000° C., is the printing of markings such as data matrix codes using special ceramic inks. When the components are coated or painted, this marking, which comprises a layer height of less than 100 μm, for example, is covered and can no longer be read using conventional methods such as a camera with image evaluation or topography measurement. A non-destructive and preferably non-contact method is therefore required to read this marking under the coating. An example application is the reading of a marking before and after cathodic dip painting, or CDP for short, which can be used to protect components against corrosion, for example.

This problem has not yet been solved for printed markings. These markings are not yet readable after the coating step and can therefore no longer be used. For other, generally more complex marking solutions, such as engravings, it may still be possible to read the marking by measuring the topography.

In the process described here, the marking forms a layer system with the substrate and the covering layer with different physical properties and interfaces. For example, differences in heat propagation can be resolved locally using active thermography.

For thermography, the component is heated or alternatively cooled in at least one region with the marking in order to make differences in thermal conductivity visible. Depending on the ink composition, the marking will have a different thermal conductivity and/or heat capacity than the substrate and/or the covering layer. Consequently, when the temperature changes, the regions with the marking will have a different temperature than the surrounding area, possibly only for a short time. For a good temperature contrast, the temperature change should be as homogeneous as possible across the component, the temperature difference should be as large as possible and the energy input and/or heat input should occur on a short time scale.

Such a temperature change is achieved, for example, with an intense flash lamp whose energy pulse is absorbed by the component surface. The energy is converted into heat, which in turn is transferred to the inside of the sample and/or the environment. This process depends on the heated material, in particular its thermal conductivity and/or heat capacity, as well as the interfaces, that is, the associated heat transfer coefficients. The resulting temperature differences can be visualized with a thermal imaging camera after excitation. Preferably, excitation and detection are synchronized. Depending on the excitation energy, the temperature difference is visible for a few milliseconds, for example. The thermal image obtained can then be analyzed using image evaluation with adapted algorithms in order to find and read out the marking. This means that the marking can be machine-readable.

The method described here therefore enables the contactless and non-destructive detection of hidden markings after the component has been coated. Seamless traceability across an entire process chain is possible and thus also the digitalization of production processes. Component identification can be achieved across technical/operational interfaces, for example from suppliers to further processing.

Alternative possibilities, which may in principle be possible for reading a marking covered by a layer, are, for example:
laser speckle photometry, although the topography contrast is too low, especially after CDP;
optical coherence tomography, whereby the transmission of required radiation may be prevented in the CDP coating, for example;
electromagnetic ultrasound, EMUS for short, whereby no sensitivity to surface structures is guaranteed;
eddy current, whereby the lateral resolution is generally too low; and/or
X-ray methods.

The method described herein can be used, for example, in the tracking of printed, like metallic components, particularly along the entire process chain, such as in the automotive industry. Furthermore, the present method can be used in the digitalization of processing steps.

To summarize briefly, in the process described here, excitation radiation can be absorbed by an infrared-impermeable coating. The absorbed energy then flows partially into the component in the form of heat. The different thermal conductivity values and heat capacities of the materials then come into play. Due to the marking material, which exhibits a different behavior with regard to the dissipation of heat compared to the covering layer without marking, the marking can then be read by means of thermal imaging or infrared scanning.

According to at least one embodiment, in step C) the at least one covering layer is heated by means of an energy flash. The electromagnetic radiation of the radiation flash can be coherent or also incoherent radiation. A laser, such as a titanium-sapphire laser or a CO₂ laser, or a flash lamp, such as a Xe flash lamp, can be used for the radiation flash. Other examples of possible light sources are halogen lamps and infrared emitters, which heat the region with the marking continuously and thus comparatively slowly. Nevertheless, a thermographic contrast can result if the thermal properties, such as thermal conductivity, heat capacity and/or absorption coefficient in the relevant spectral range of the materials involved are selected appropriately.

The covering layer is preferably irradiated over the entire surface of the marking. This means that a large region of the workpiece can be exposed and thus heated at the same time. For example, the region of the workpiece illuminated by the radiation flash is larger than the marking itself by at least a factor of 10 or by at least a factor of 100 or by at least a factor of 1000 when viewed from above the covering layer. This allows the marking to be read, even if the exact position of the marking is not known.

Alternatively, the workpiece can be illuminated only locally in the region of the marking or the workpiece can be scanned with a beam bundle diameter that is smaller than the mean diameter of the marking. ‘Mean diameter’ D means, for example, the square root of 4A/T, where A is an area over which the marking extends.

According to at least one embodiment, the radiation flash comprises a duration of at most 50 ms or at most 20 ms or at most 10 ms or at most 5 ms. “Short-term irradiation” can therefore refer to these durations.

According to at least one embodiment, the substrate comprises a thermal conductivity that is higher than that of the marking material by at least a factor of 1.25 or by at least a factor of 1.5 or by at least a factor of 2 or by at least a factor of 5 or by at least a factor of 10. Alternatively or additionally, this factor is at most 100 or at most 50.

According to at least one embodiment, the substrate comprises a heat capacity that is higher than that of the marking material by at least a factor of 1.25 or by at least a factor of 1.5 or by at least a factor of 2 or by at least a factor of 5 or by at least a factor of 10. Alternatively or additionally, this factor is at most 100 or at most 50.

According to at least one embodiment, the at least one covering layer comprises a thermal conductivity that is at least a factor of 1.1 or at least a factor of 1.5 or at least a factor of 2 higher than that of the marking material. Alternatively or additionally, this factor is at most 10 or at most 5.

According to at least one embodiment, the at least one covering layer comprises a thermal conductivity that is at least a factor of 1.1 or at least a factor of 1.5 or at least a factor of 2 lower than that of the marking material. Alternatively or additionally, this factor is at most 10 or at most 5.

According to at least one embodiment, the marking material comprises at least one glass, at least one ceramic and/or at least one glass-ceramic. It is possible that the marking material consists of at least one glass, at least one ceramic and/or at least one glass-ceramic.

According to at least one embodiment, the marking material comprises or consists of at least one aluminum oxide and/or at least one silicon oxide.

For example, the marking material comprises or is an island silicate, for example a mullite. Mullites are from the class of “silicates and germanates” with the complex chemical composition Al^{[6]}Al₁₊ₓ^{[4]}[O|Si₁₋ₓO_{4-x/2}], where x≈0.2, for example 0.15≤x≤0.25. Furthermore, the marking material can be or can comprise partially stabilized zirconia, also referred to as PSZ. Yttrium-stabilized zirconia, YSZ for short, is also possible for the marking material.

According to at least one embodiment, the substrate is a metal sheet or comprises a metal sheet. For example, the metal sheet comprises a thickness of at least 30 μm or at least 0.1 mm and/or the thickness is at most 4 mm or at most 2 mm or at most 0.5 mm.

According to at least one embodiment, the substrate comprises a sheet steel or sheet iron. An anti-scaling layer can be applied directly to the metal sheet.

According to at least one embodiment, the anti-scaling layer comprises or consists of aluminum, silicon, zinc and/or at least one metal oxide. For example, the anti-scaling layer is a layer produced by hot-dip galvanizing or a layer made of an aluminium-silicon alloy. Protective layers made of or with metal oxides such as aluminum oxide can also be used. The anti-scaling layer can also be a protective coating with particles on the nanometer scale, for example, an x-tec coating from the manufacturer NANO-X GmbH. A thickness of the anti-scaling layer is, for example, at least 100 nm or at least 250 nm or at least 1 μm and/or at most 30 μm or at most 10 μm or at most 2 μm. A preferred composition of the anti-scaling layer is: 87% Al, 10% Si and 3% Fe. The preferred thickness of the anti-scaling layer is between 1 μm and 40 μm.

According to at least one embodiment, the marking is created directly on the anti-scaling layer. This means that an ink with the marking material can be printed on the anti-scaling layer. Alternatively, the ink and thus the marking is applied directly to the metal sheet. This means that the marking material can be located on the substrate or on the anti-scaling layer.

According to at least one embodiment, the at least one covering layer is formed of a cathodic dip coating, a filler, a basecoat and/or a clearcoat. This means that a stack of covering layers can be used, for example, as a stack of paint layers of a motor vehicle.

According to at least one embodiment, step A) comprises the following substeps, in particular in the specified order:
A1) providing the substrate,
A2) applying the marking material to the substrate, and
A3) carrying out a hot forming and/or an open-die forging and/or a press hardening of the substrate, the marking being readable after the hot forming.

Optionally, it is possible that step A3) comprises the creation of surface contours, for example, engraving. The marking material can be partially or completely applied in such surface contours. In this case, step A3) can precede step A2).

According to at least one embodiment, the marking is composed of a plurality of dots of the marking material. For example, the marking material is then applied by means of printing. The individual dots can form contiguous larger regions.

According to at least one embodiment, the dots comprise an average diameter of at least 0.1 mm or at least 0.3 mm. Alternatively or additionally, this mean diameter is at most 3 mm or at most 1 mm.

According to at least one embodiment, an average thickness of the marking material and/or the marking is at least 1 μm or at least 4 μm. Alternatively or additionally, this average thickness is at most 10 μm or at most 0.03 mm or at most 0.1 mm.

According to at least one embodiment, a thickness of the substrate exceeds the average thickness of the marking material by at least a factor of 10 or by at least a factor of 20 or by at least a factor of 50. Alternatively or additionally, this factor is at most 104 or at most 103. In other words, the marking hardly contributes to a total thickness of the workpiece.

According to at least one embodiment, the marking and/or the marking material is partially or completely present as elevations on the substrate. In other words, the substrate may comprise a flat or approximately flat surface in the region of the marking and the marking is applied onto this surface.

According to at least one embodiment, the marking and/or the marking material is flush with the substrate or is partially or completely recessed in the substrate. In this case, the substrate comprises a surface that is perforated in the region of the marking, for example, by an engraving. The marking material is then partially or completely arranged in trenches or holes that break through the surface.

According to at least one embodiment, the method comprises the step of applying at least one ink for a marking to the substrate. It is possible that multi-colored markings are produced and that several different inks can be used accordingly. Preferably, however, only exactly one ink is used. The ink comprises the at least one marking material.

According to at least one embodiment, the ink is only applied locally. In particular, the ink is only applied to the substrate where the ink is actually required for the marking. Subsequent removal of colored material from the ink in relation to the workpiece can therefore be omitted.

According to at least one embodiment, the method comprises the step of fixing the ink so that the marking results. During fixing, the ink is preferably brought to a temperature of at least 400° C. or at least 500° C. or at least 600° C. for a short time. Alternatively or additionally, this temperature is at most 1200° C. or at most 1000° C. or at most 950° C. The components of the ink that form the marking are firmly bonded to the substrate by the effect of the temperature.

It is possible that not all components of the originally applied ink are still present when fixing. This means that the ink may already be pre-dried during fixing, for example by evaporating a solvent from the ink. With such optional pre-drying, there is preferably no or no pronounced temperature treatment. This means that pre-drying can take place at temperatures below 150° C. or below 100° C., preferably at room temperature, that is, around 25° C.

According to at least one embodiment, the ink additionally comprises an inorganic binder, which may also be contained in the finished marking. In the ink, the inorganic binder is preferably present in the form of particles. An average particle diameter of the particles of the binder in the ink is preferably at least 10 nm or at least 0.1 μm or at least 0.2 μm and/or at most 0.1 mm or at most 50 μm or at most 10 μm.

According to at least one embodiment, the ink contains ceramic pigments. Preferably, the ceramic pigments provide a coloring and/or a contrast of the marking with respect to the workpiece. The term “ceramic pigments” includes glass-ceramics comprising amorphous and crystalline sub-regions. It is possible that such a glass-ceramic is just formed by the fixing, whereby such a glass-ceramic then preferably consists of the binder and the ceramic pigments. The marking material can be formed by the pigments or can comprise the pigments.

For example, the ceramic pigments and/or the finished marking are made of one or more of the following materials or comprise one or more of these materials: Oxides such as BeO, MgO, Al₂O₃, SiO₂, CaO, TiO₂, Cr₂O₃, MnO, Fe₂O₃, ZnO, SrO, Y₂O₃, BaO, CeO₂, UO₂; carbides such as Be₂C, Be₄C, Al₄C₃, SiC, TiC, Cr₃C₂, Mn₃C, Fe₃C, SrC₂, YC₂, ZrC, NbC, Mo₂C, BaC₂, CeC₂, HfC, TaC, WC, UC; nitrides such as Be₃N₂, BN, Mg₃N₂, AlN, Si₃N₄, Ca₃N₂, TiN, VN, CrN, Mn₃N₂, Sr₃N₂, ZrN, NbN, MO₃N₂, HfN, TaN, WN₂, UN; borides such as AlB₄, CaB₆, TiB₂, VB₂, CrB₂, MnB, FeB, CoB, NiB, SrB₆, YB₆, ZrB₂, NbB₂, MoB₂, BaB₆, LaB₆, CoB₆, HfB₂, TaB₂, WB; silicides such as CaSi, Ti₅Si₃, V₅Si₃, CrSi₂, FeSi, CoSi, ZrSi₂, NbSi₂, MoSi₂, TaSi₂, WSi₂. Oxidic glasses, such as silicate or borate glasses, as well as multiphase materials, such as Al₆Si₂O₁₃, or mixed crystals such as from the system Al₂O₃—Cr₂O₃, MgSiO₄, CaSiO₄, ZrSiO₄, MgAl₂O₄, CaZrO₃, SiAlON, AlON and/or B₄C—TiB₂ can also be used. It is also possible to use ceramic pigments with a non-stoichiometric composition.

For example, one or more of the following marking materials are used, alone or in any combination:
purple pigments such as BaCuSi₂O₆, cobalt orthophosphates such as NH₄MnP₂O₇,
blue pigments such as sulphur-containing sodium silicate Na₈₋₁₀Al₆Si₆O₂₄S₂₋₄, (Na,Ca)₈(AlSiO₄)₆(S,SO₄,Cl)₁₋₂, cobalt (II) stannate, CaCuSi₄O₁₀, BaCuSi₄O₁₀, Cu₃(CO₃)₂(OH)₂, Fe₇(CN)₁₈, YIn₁₋ₓMnₓO₃,
green pigments such as CdS in combination with Cr₂O₃, (Cr₂O₃·H₂O), CoZnO₂, Cu₂CO₃(OH)₂, CuHAsO₃ or
   K[(Al,FeIII),(FeII,Mg)](AlSi₃,Si₄)O₁₀(OH)₂,
Yellow pigments such as₂S₃, BiVO₄, PbCrO₄, K₃Co(NO₂)₆, Fe₂O₃·H₂O, PbSnO₄, Pb(Sn,Si)O₃, SnS₂, cadmium sulphoselenide, PbCrO₄+PbO,
red pigments such as₄S₄, Cd₂SSe, Pb₃O₄, HgS, and/or
black pigments such as Fe₃O₄, MnO₂, Ti₂O₃.

According to at least one embodiment, a median particle diameter of the pigments in the ink and/or in the finished marking is at least 10 nm or at least 50 nm or at least 0.1 μm and/or at most 30 μm or at most 5 μm or at most 500 nm or at most 200 nm. The term “median diameter” preferably refers to a D50 value, that is, a median value. It is possible that the median diameter of the ceramic pigments in the ink is larger or smaller than the median diameter of the particles of the binder, for example, by a factor of at least 2.

According to at least one embodiment, the pigments are of Al₂O₃, SiO₂, TiO₂ and/or ZrO₂. A binder may comprise, for example, SiO₂ as the main component.

According to at least one embodiment, in step A3), which is carried out in particular after step A2), the substrate undergoes hot forming, for example, pressing or deep drawing of, for example, stamped, planar sheets at a forming temperature. Particularly in the case of steel sheets or iron sheets, the forming temperature is preferably at least 700° C. or at least 800° C. or at least 880° C. Alternatively or additionally, the forming temperature is at most 1100° C. or at most 1000° C. or at most 950° C. In particular, the forming temperature is approximately 920° C. The marking is preferably fixed at a temperature below the forming temperature, for example, at least 200° C. below the forming temperature.

According to at least one embodiment, the ink and thus the marking comprise at least one phosphor. The at least one phosphor can be used to increase the contrast between the marking and the substrate. In particular, the pigments consist of at least one ceramic or glass-ceramic phosphor. Such a phosphor allows the marking to be read efficiently as long as the at least one covering layer has not yet been applied.

The marking material therefore contains, for example, one or more of the following phosphors or consists of one or more of these phosphors:Eu²⁺-doped nitrides such as (Ca,Sr)AlSiN₃:Eu²⁺, Sr(Ca,Sr)Si₂Al₂N₆:Eu²⁺, (Sr,Ca)AlSiN₃*Si₂N₂O:Eu²⁺, (Ca,Ba,Sr)₂Si₅N₈:Eu²⁺, (Sr,Ca)[LiA₁₃N₄]:Eu²⁺; garnets from the general system (Gd,Lu,Tb,Y)₃(Al,Ga,D)₅(O,X)₁₂:RE where X=halide, N or divalent element, D=trivalent or tetravalent element and RE=rare earth metals such as Lu₃(Al₁₋ₓGaₓ)₅O₁₂:Ce³⁺, Y₃(Al₁₋ₓGaₓ)₅O₁₂:Ce³⁺; Eu²⁺-doped sulfides such as (Ca,Sr,Ba)S:Eu²⁺; Eu²⁺-doped SiONs such as (Ba,Sr,Ca)Si₂O₂N₂:Eu²⁺; SiAlONs such as from the system LiₓM_{y}Ln_{z}Si₁₂₋₍ₘ₊ₙ₎Al₍ₘ₊ₙ₎Oₙ₁₆₋ₙ; beta-SiAlONs from the system Si₆₋ₓAl_{z}O_{y}N_{8-y}:RE_{z}; nitrido-orthosilicates such as AE₂₋ₓ₋ₐREₓEuₐSiO₄₋ₓNₓ, AE₂₋ₓ₋ₐREₓEuₐSi_{1-y}O_{4-x-2y}Nₓ where RE=rare earth metal and AE=alkaline earth metal; orthosilicates such as (Ba,Sr,Ca,Mg)₂SiO₄:Eu²⁺; chlorosilicates such as Ca₈Mg(SiO₄)₄Cl₂:Eu²⁺; chlorophosphates such as (Sr,Ba,Ca,Mg)₁₀(PO₄)₆Cl₂:Eu²⁺; BAM phosphors from the BaO—MgO—Al₂O₃ system such as BaMgAl₁₀O₁₇:Eu²⁺; halophosphates such as M₅(PO₄)₃(Cl,F):(Eu²⁺,Sb³⁺,Mn²⁺); SCAP phosphors such as (Sr,Ba,Ca)₅(PO₄)₃Cl:Eu²⁺.

In addition, a workpiece is provided. In particular, the workpiece is produced by a method as disclosed in connection with one or more of the above embodiments. Features of the method are therefore also disclosed for the workpiece and vice versa.

In at least one embodiment, the workpiece comprises:
a substrate comprising a metal sheet,
a marking comprising a marking material, and
at least one opaque covering layer so that the marking is located between the substrate and the at least one opaque covering layer,
wherein the marking material comprises a thermal conductivity which is by at least a factor of 1.25 or at least a factor of two lower than that of the substrate and/or than that of the covering layer.

### BRIEF DESCRIPTION OF THE DRAWINGS

In the following, a method described here and a workpiece described here are explained in more detail with reference to the drawing using exemplary embodiments. Identical reference signs indicate identical elements in the individual figures. However, no references to scale are shown; rather, individual elements may be shown in exaggerated size for better understanding.

FIG. 1 shows a schematic side view of a process step of an exemplary embodiment of a process described herein;

FIG. 2 shows a schematic block diagram of an exemplary embodiment of a process described here for workpieces described here;

FIGS. 3 to 6 show schematic sectional views of exemplary embodiments of workpieces described herein; and

FIGS. 7 and 8 show schematic top views of exemplary embodiments of workpieces described herein.

### DETAILED DESCRIPTION OF ILLUSTRATIVE EMBODIMENTS

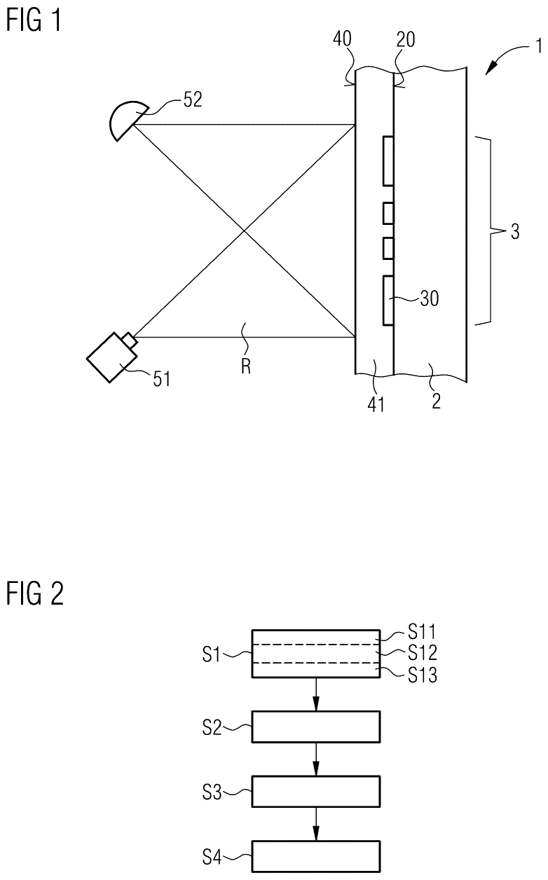

FIG. 1 shows an example of a workpiece 1. The workpiece 1 comprises a substrate 2, for example, a metal sheet. A marking 3 is located on a top side 20 of the substrate 2, which is, for example, a label of the workpiece 1 and enables the workpiece 1 to be identified. The marking 3 is or comprises, for example, a QR code, a bar code, a data matrix code, an inscription and/or a graphic.

A covering layer 41, such as a lacquer, is applied over the marking 3 across the top side 20. The covering layer 41 is opaque, so that the marking 3 is no longer visually legible due to the covering layer 41.

To read the marking 3, a radiation source 51 is therefore used to irradiate a top side 40 of the covering layer 41 facing away from the substrate 2 with a radiation R. The radiation R is or comprises in particular ultraviolet radiation, visible light and/or infrared radiation. For example, the radiation source 51 is a laser or a flash lamp, such as a Xe flash lamp.

The covering layer 41 absorbs at least part of the radiation R, so that this part of the radiation R is converted into heat. Due to different thermal conductivities, heat capacities and/or heat transfer coefficients towards a marking material 30, of which the marking 3 is made, and towards a material of the substrate 2, a temperature distribution is established which corresponds to the marking 3. This temperature distribution, and thus the marking 3, is detected by a thermal imaging camera 52. That is, the thermal imaging camera 52 observes a region with the marking 3 of the top side 40 of the covering layer 4. The thermal imaging camera 52 is sensitive, for example, in at least part of the spectral range from 3 μm to 15 μm.

The irradiating with the radiation R and the observation with the thermal imaging camera 52 is preferably synchronized in time. The temperature distribution due to the flash with the radiation R occurs, for example, within 10 ms or within 5 ms or within 2 ms and lasts, for example, only 10 ms or 5 ms at most. The entire process of irradiating and readout takes, for example, a maximum of 20 ms or a maximum of 10 ms.

A temperature difference between the marking and its surroundings on the workpiece 1 due to the radiation R is, for example, at least 25 mK, in particular at least 0.1 K and at most 3 K.

For example, the energy per flash of radiation R is at least 0.03 kJ or at least 0.2 kJ or at least 2 kJ. Alternatively or additionally, this energy is at most 0.1 MJ or at most 50 kJ or at most 10 kJ. These values apply in particular to lamps, such as halogen lamps, with a broad emission spectrum. In the case of spectrally narrow-band emission, such as lasers, lower values may also be sufficient, for example, at least 0.01 kJ and/or at most 1 kJ, for example in the case of a laser with an emission wavelength of 808 nm. The energy values can be adjusted depending on the area content of a region to be exposed, which includes the marking.

According to FIG. 1, irradiation with the radiation R is carried out over a large area and also in regions that are free of the marking 3. Alternatively, the workpiece 1 can also be screened or scanned with the radiation 3.

This allows the marking 3 to be read reliably and quickly and enables seamless tracking of the workpiece 1 in a process chain, for example in the manufacture of a motor vehicle.

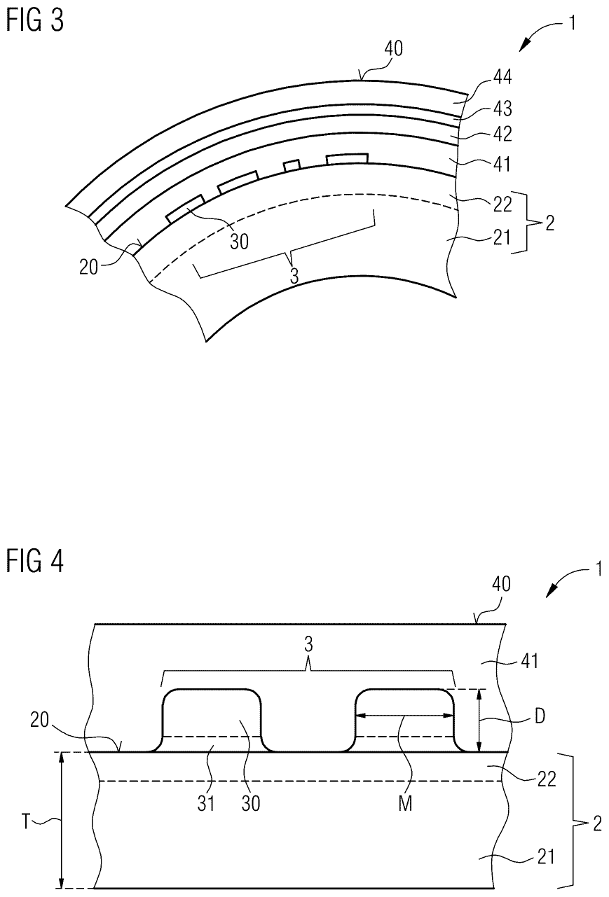

FIG. 2 shows a corresponding method schematically as a block diagram. In a step S1, the marking 3 is provided on the substrate 3, wherein the marking 3 is formed from the at least one marking material 30.

Optionally, step S1 comprises one or more sub-steps, for example step S11, in which the substrate 2 is provided. In a subsequent step S12, the marking material 30 is applied to the substrate 2. The substrate can then be shaped in a step S13, for example by hot forming and/or open-die forging and/or press hardening. Since the marking 3 is in particular a ceramic marking, the marking can withstand the high temperatures of at least 600° C. that occur during shaping, for example, and is still legible even after step S13.

In a step S2, at least one opaque covering layer 41, 42, 43, 44 is provided, which covers the marking 3. Steps S1 and S2 can be carried out simultaneously, that is, the finished workpiece 1 which comprises the substrate 2, the marking 3 and the covering layer 41, 42, 43, 44, is then provided before the marking 3 is read out.

In a step S3, the at least one covering layer 41, 42, 43, 44 is briefly irradiated with the electromagnetic radiation R, for which the at least one covering layer 41, 42, 43, 44 is impermeable, so that the at least one covering layer 41, 42, 43, 44 heats up.

Finally, in step S4, a non-contact readout of the marking 3 is carried out using thermal imaging. In step S4, the briefly occurring imbalance temperature distribution due to the irradiation is determined and the mark 3 is detected.

In all other respects, the comments on FIG. 1 apply in the same way to FIG. 2, and vice versa.

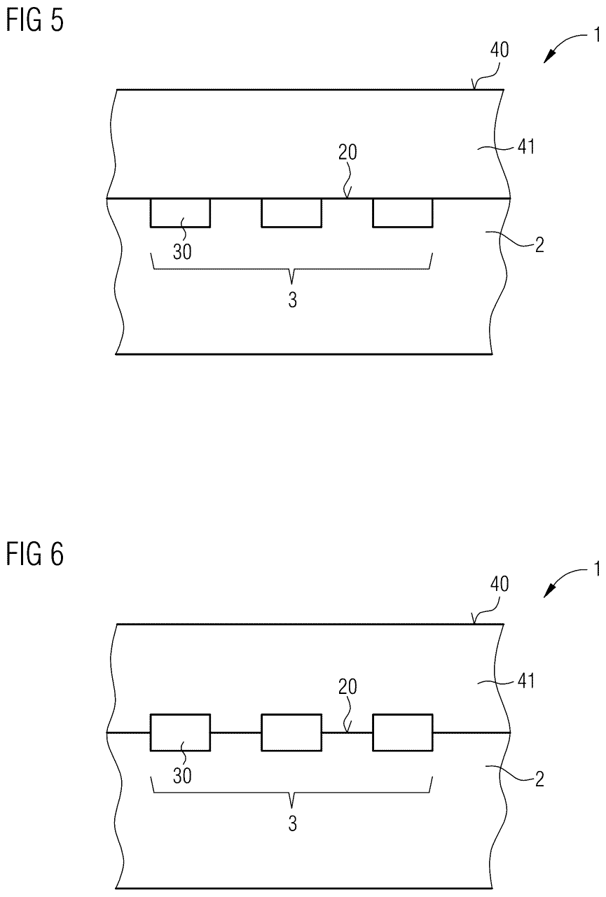

FIG. 3 shows another example of the workpiece 1. In this example, the workpiece 1 comprises a curvature. The curvature can extend over a region with the marking. Alternatively, the workpiece 1 can be flat in the region of the marking 3 and comprises the curvature only out of the region with the marking 3.

For example, the marking 3 is composed of a large number of dots with the marking material 30. The dots may comprise different sizes or alternatively may all be of the same size, as viewed from above on the substrate top side 20. The dots are applied to the substrate top side 20.

Furthermore, FIG. 3 illustrates that the substrate 2 can be composed of several components 21, 22. For example, a metal sheet 21, such as a steel sheet, is present. A thickness T of the metal sheet 21 is, for example, between 0.1 mm and 0.6 mm inclusive. The metal sheet 21 is, for example, a manganese-boron steel.

Optionally, there is a protective layer on the upper side of the substrate 20, such as an anti-scaling layer 22. The anti-scaling layer 22 protects the metal sheet 21 from oxidation during hot forming. The anti-scaling layer 22 is made of an aluminum-silicon alloy, for example. A thickness of the anti-scaling layer 22 is, for example, between 2 μm and 20 μm, so that the anti-scaling layer 22 can be very thin compared to the metal sheet 21.

According to FIG. 3, several of the covering layers 41, 42, 43, 44 are present, so that a stack of covering layers is formed. This can also be the case in all other examples of workpiece 1. A first covering layer 41 directly on the substrate 2 and on the marking 3 is, for example, a cathodic dip coating layer. CDP layers are usually black and opaque, so that the marking 3 is no longer visually recognizable. A second covering layer 42, such as a filler, is applied to the first covering layer 41. One side of the second covering layer 42 facing away from the substrate 2 is preferably smooth, so that at the latest after the second covering layer 42 has been applied, a contour of the marking 3 is no longer recognizable and the marking 3 can no longer be felt. Finally, a basecoat is applied as the third covering layer 43 and finally a clear coat is applied as the fourth covering layer 44. A thickness D of the stack of covering layers 41, 42, 43, 44 is, for example, between 50 μm and 0.2 mm inclusive, see also FIG. 4.

In the case of a steel sheet, the metal sheet 21 comprises a specific thermal conductivity in the region of 15 W/(m*K) to 50 W/(m*K), depending on the alloy. A specific thermal conductivity of the optional anti-scaling layer 22 is typically in the region of 130 W/(m*K) to 150 W/(m*K) in the case of an aluminum-silicon alloy. The specific thermal conductivity of the covering layer or stack of covering layers is, for example, between 1 W/(m*K) and 10 W/(m*K) inclusive.

FIG. 4 shows the marking 3 of FIG. 3 in more detail. Optionally, the marking 3 can comprise an adhesion promoter 31. Unlike shown in FIG. 4, the adhesion promoter 31 need not be limited to the points with the marking material 30, but can extend as a continuous, gapless layer over an entire region with the marking 3. For example, the adhesion promoter 31 is made of a glass and then comprises a specific thermal conductivity, for example, in the region of 1 W/(m*K) to 12 W/(m*K). Such an adhesion promoter 31 can also be present in all other examples.

The marking material 30, which is mainly responsible for a visual as well as a thermal contrast with respect to the substrate 2, is or comprises, for example, Al₂O₃ with a specific thermal conductivity in the region of 6 W/(m*K) to 8 W/(m*K) or a 3Al₂O₃-2SiO₂ mullite with a specific thermal conductivity in the region of 2 W/(m*K) to 6 W/(m*K) or partially stabilized zirconium oxide, PSZ, with a specific thermal conductivity in the region of 1 W/(m*K) to 3 W/(m*K).

The dots of the marking 3 comprise, for example, an average diameter M of between 0.1 mm and 3 mm with an average thickness D of, for example, at least 1 μm and at most 10 μm or at most 100 μm.

In all other respects, the comments on FIGS. 1 and 2 apply in the same way to FIGS. 3 and 4, and vice versa.

FIG. 5 illustrates that the marking 3 is not applied to the top side 20 of the substrate 2 but is completely recessed in the substrate 2. For example, the marking material 30 is flush with the substrate top side 20. Such a marking 3 can be produced, for example, by first creating an engraving in the substrate 2 and depositing the marking material 30 in the engraving. Alternatively, the marking material 30 can be pressed into the substrate 2.

In contrast, according to FIG. 6, the marking material 30 partially protrudes beyond the substrate top side 20 and is only partially inserted into the substrate 2.

In all other respects, the explanations to FIGS. 1 to 4 apply in the same way to FIGS. 5 and 6, and vice versa.

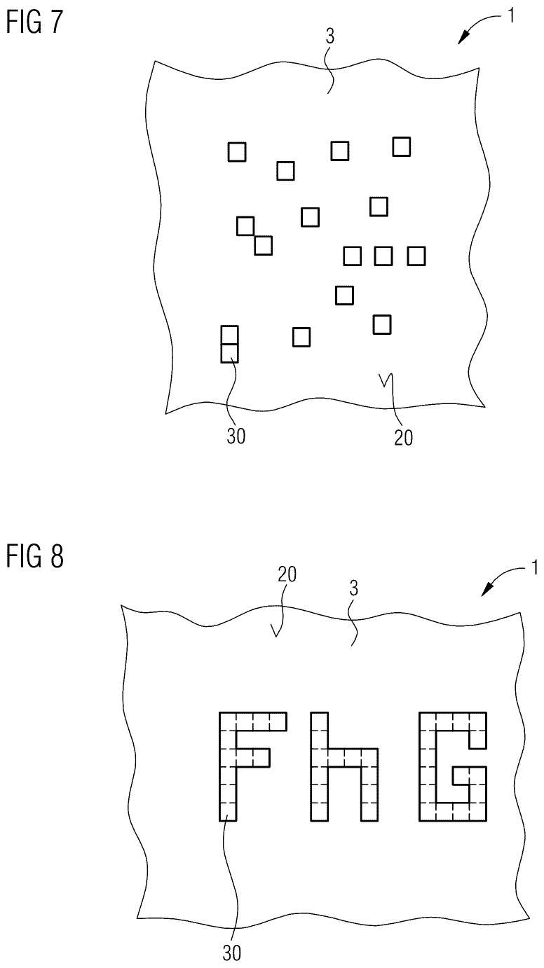

FIG. 7 shows that a code, such as a QR code, can be realized by the marking 3 when viewed from above. The dots of the marking 3 can thus be distributed relatively loosely across the top side of the substrate 20.

In contrast, FIG. 8 shows that the dots can combine to form a lettering. The individual dots are symbolized by dashed lines.

The marking 3 may comprise a mixture of the shapes shown in FIGS. 7 and 8.

In all other respects, the comments on FIGS. 1 to 6 apply in the same way to FIGS. 7 and 8, and vice versa.

The components shown in the figures preferably follow one another in the order indicated, in particular directly on top of each other, unless otherwise described. Components not touching each other in the figures preferably comprise a distance to each other. If lines are drawn parallel to each other, the associated surfaces are preferably also aligned parallel to each other. Furthermore, the relative positions of the drawn components to each other are correctly shown in the figures, unless otherwise indicated.

The invention described herein is not limited by the description based on the exemplary embodiments. Rather, the invention includes any new feature as well as any combination of features, which includes in particular any combination of features in the patent claims, even if this feature or combination itself is not explicitly stated in the patent claims or exemplary embodiments.

What is claimed is:

1. A method for reading a marking, the method comprising:
providing the marking on a substrate, the marking being formed with at least one marking material;
providing at least one opaque covering layer covering the marking;
briefly irradiating the at least one covering layer with electromagnetic radiation to which the at least one covering layer is impermeable; and
contactless reading the marking by thermal imaging.

2. The method according to claim 1,
wherein briefly irradiation the at least one covering layer comprises heating by a radiation flash, and
wherein the radiation flash comprises a duration of at most 50 ms.

3. The method according to claim 1,
wherein the substrate comprises a thermal conductivity higher by at least a factor of 2 than the marking material.

4. The method according to claim 1,
wherein the marking material comprises a glass, a ceramic and/or a glass-ceramic.

5. The method according to claim 4,
wherein the marking material comprises at least one aluminum oxide and/or at least one silicon oxide.

6. The method according to claim 1,
wherein the substrate is a metal sheet or comprises a metal sheet.

7. The method according to claim 6,
wherein the substrate comprises a steel sheet as the metal sheet and an anti-scaling layer directly applied
to the metal sheet, and
wherein the marking material is located on the anti-scaling layer (22).

8. The method according to claim 1,
wherein the at least one covering layer is formed from a cathodic dip coating, a filler, a base coating and/or a clear coating.

9. The method according to claim 1,
providing the marking on the substrate comprises the following substeps in the specified order:
providing the substrate,
applying the marking material onto the substrate, and
carrying out a hot forming and/or an open-die forging and/or a press hardening of the substrate, and
wherein the marking is readable after the hot forming.

10. The method according to claim 1,
wherein the marking is composed of a plurality of dots of the marking material, and
wherein the dots have an average diameter of at least 0.1 mm and of at most 3 mm.

11. The method according to claim 1,
wherein an average thickness of the marking material is between 1 μm and 0.03 mm, inclusive,
wherein a thickness of the substrate exceeds the average thickness of the marking material by at least a factor of 10.

12. The method according to claim 1,
wherein the marking material is present as elevations on the substrate.

13. The method according to claim 1,
wherein the marking material is flush with the substrate or is at least partially recessed in the substrate.

14. A workpiece manufactured by the method of claim 1 comprising:
the substrate having a metal sheet;
the marking having the marking material; and
the at least one opaque covering layer,
wherein the marking is located between the substrate and the at least one opaque covering layer, and
wherein the marking material comprises a thermal conductivity, which is at least a factor of two lower or higher than that of the substrate.
